(19) United States
(12) Patent Application Publication
(10) Pub. No.: US 2025/0028272 A1
(43) Pub. Date: Jan. 23, 2025

(54) CO2 EMISSION ESTIMATION SYSTEM AND NON-TRANSITORY COMPUTER-READABLE RECORDING MEDIUM WITH CO2 EMISSION ESTIMATION PROGRAM STORED THEREON

(71) Applicant: KYOCERA Document Solutions Inc., Osaka (JP)

(72) Inventors: Naoki TAKEUCHI, Osaka (JP); Osamu HIROKAWA, Osaka (JP); Akira YUKI, Osaka (JP); Keita MIYAMOTO, Osaka (JP); Ryota YAGANE, Osaka (JP); Miyuki HARA, Osaka (JP)

(73) Assignee: KYOCERA Document Solutions Inc., Osaka (JP)

(21) Appl. No.: 18/773,620

(22) Filed: Jul. 16, 2024

(30) Foreign Application Priority Data
Jul. 19, 2023 (JP) 2023-117911

(51) Int. Cl. G03G 15/00; G06K 15/00

(52) U.S. Cl. CPC G03G 15/55; G03G 15/5016; G06K 15/002; G06K 15/40

(57) ABSTRACT

A CO2 emission estimation system includes a CO2 emission estimator. The CO2 emission estimator calculates an estimated value of CO2 emissions from an image forming apparatus when performing a job, using a CO2 emission estimation model as a formula for estimating the CO2 emissions and settings for the job. The CO2 emission estimation model is a formula where a multiple regression expression for determining an estimated value of a power consumption of the image forming apparatus when performing the job is multiplied by a CO2 emission factor. The CO2 emission estimation model has a plurality of explanatory variables each according to a different type of setting for the job.

### INCORPORATION BY REFERENCE

This application claims priority to Japanese Patent Application No. 2023-117911 filed on Jul. 19, 2023, the entire contents of which are incorporated by reference herein.

### BACKGROUND

The present disclosure relates to CO2 emission estimation systems and CO2 emission estimation programs that estimate CO2 emissions from image forming apparatuses.

There is known a CO2 emission estimation system that multiplies a reference amount of power previously determined from measurement of a power consumption of an image forming apparatus by a print mode factor associated with a print mode indicating that images are to be printed in black and white or multicolor, further multiplies the obtained value by a layout factor associated with a layout indicating the number of pages to be printed per sheet of paper to obtain a power consumption of the image forming apparatus when performing one job, and multiplies the obtained power consumption by CO2 emissions per unit power consumption to determine an estimated value of CO2 emissions from the image forming apparatus. In this CO2 emission estimation system, the reference amount of power is, for example, an amount of power consumed by black and white printing on a page of A4 paper. The print mode factor is set to “1” in a print mode where images are printed in black and white, and a greater value than “1” in another print mode where images are printed in multicolor. The layout factor is set to “1” in a layout “nothing” where one page of a document is printed on one side of a single sheet of paper, “0.5” in a layout “2 in 1” where two pages of a document are printed on one side of a single sheet of paper, “0.25” in a layout “4 in 1” where four pages of a document are printed on one side of a single sheet of paper, and “0.125” in a layout “8 in 1” where eight pages of a document are printed on one side of a single sheet of paper.

There is also known another CO2 emission estimation system that multiplies respective power consumptions of actuated devices, each power consumption defined for the relevant actuated device and depending on print settings, by the numbers of actuations of the actuated devices, respectively, each number of actuations depending on the numbers of sheets and sides to be printed, to obtain a power consumption of an image forming apparatus when performing one job and multiplies the obtained power consumption by a CO2 emission factor depending on the type of power to determine an estimated value of CO2 emissions from the image forming apparatus.

### SUMMARY

A technique improved over the aforementioned techniques is proposed as one aspect of the present disclosure.

A CO2 emission estimation system according to an aspect of the present disclosure includes a controller. The controller includes a processor and functions, through the processor executing a CO2 emission estimation program, as a CO2 emission estimator that calculates an estimated value of CO2 emissions from an image forming apparatus when performing a job, using a CO2 emission estimation model as a formula for estimating the CO2 emissions and settings for the job. The CO2 emission estimation model is a formula where a multiple regression expression for determining an estimated value of a power consumption of the image forming apparatus when performing the job is multiplied by a CO2 emission factor. The CO2 emission estimation model has a plurality of explanatory variables each according to a different type of setting for the job.

In a non-transitory computer-readable recording medium with a CO2 emission estimation program stored thereon according to another aspect of the present disclosure, the CO2 emission estimation program allows a computer to act as a CO2 emission estimator that calculates an estimated value of CO2 emissions from an image forming apparatus when performing a job, using a CO2 emission estimation model as a formula for estimating the CO2 emissions and settings for the job. The CO2 emission estimation model is a formula where a multiple regression expression for determining an estimated value of a power consumption of the image forming apparatus when performing the job is multiplied by a CO2 emission factor. The CO2 emission estimation model has a plurality of explanatory variables each according to a different type of setting for the job.

### BRIEF DESCRIPTION OF THE DRAWINGS

FIG. 1 is a block diagram showing an example of an image forming apparatus serving as a CO2 emission estimation system according to one embodiment of the present disclosure.

FIG. 2 is a table showing an example of job history information shown in FIG. 1.

FIG. 3 is a block diagram showing an example of a CO2 emission estimation model generation system for generating a CO2 emission estimation model for use on the image forming apparatus shown in FIG. 1.

FIG. 4 is a flowchart of a method for generating a CO2 emission estimation model for use on the image forming apparatus shown in FIG. 1.

FIG. 5 is a flowchart of an operation of the image forming apparatus shown in FIG. 1 when performing a copy job.

FIG. 6 is a flowchart of an operation of the image forming apparatus shown in FIG. 1 when displaying the total amount of CO2 emissions.

FIG. 7 is a block diagram showing another example of a CO2 emission estimation system according to the one embodiment of the present disclosure different from the example shown in FIG. 1.

### DETAILED DESCRIPTION

Hereinafter, a description will be given of a CO2 (carbon dioxide) emission estimation system and a CO2 emission estimation program, both according to an embodiment as one aspect of the present disclosure, with reference to the drawings.

The embodiment of the present disclosure will be described below with reference to the drawings. First, a description will be given of the structure of an image forming apparatus as a CO2 emission estimation system according to one embodiment of the present disclosure.

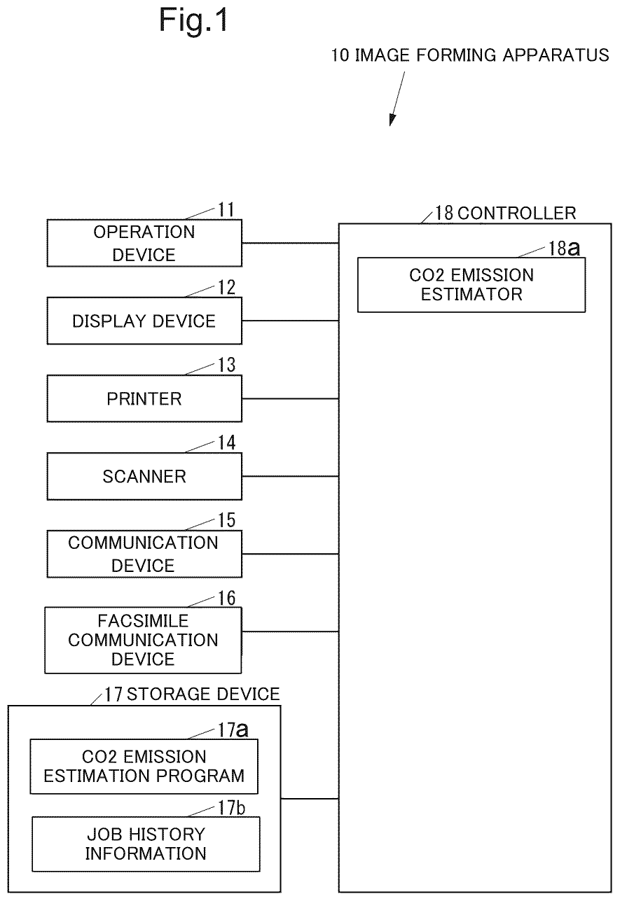

FIG. 1 is a block diagram showing an example of an image forming apparatus 10 according to this embodiment.

As shown in FIG. 1, the image forming apparatus 10 includes: an operation device 11 through which various operations are to be input and which is composed of, for example, buttons; a display device 12 on which various types of information are to be displayed and which is composed of, for example, an LCD (liquid crystal display); a printer 13 as a printing device that prints an image on a recording medium, such as a sheet of paper, and is composed of, for example, an electrophotographically image formation mechanism; a scanner 14 as a reading device that reads an image from an original document; a communication device 15 that communicates by wire or directly by wireless with external devices via a network, such as a LAN (local area network) or the Internet, or without a network connection; a facsimile communication device 16 that performs facsimile communications with unshown external facsimile devices via a communication line, such as a public phone line; a non-volatile storage device 17 which stores various types of information and which is composed of, for example, a semiconductor memory or an HDD (hard disk drive); and a controller 18 that performs overall control of the image forming apparatus 10. The image forming apparatus 10 is an example of the computer defined in CLAIMS.

The storage device 17 stores a CO2 emission estimation program 17a that allows the controller 18 to perform the operation of estimating the CO2 emissions from the image forming apparatus 10. The CO2 emission estimation program 17a may be installed on the image forming apparatus 10, for example, during production of the image forming apparatus 10, additionally installed thereon from an external storage medium, such as a USB (universal serial bus) memory or additionally installed thereon via a network. In short, the CO2 emission estimation program is stored on a non-transitory computer-readable recording medium.

The storage device 17 further stores job history information 17b into which histories of jobs performed by the image forming apparatus 10 are contained.

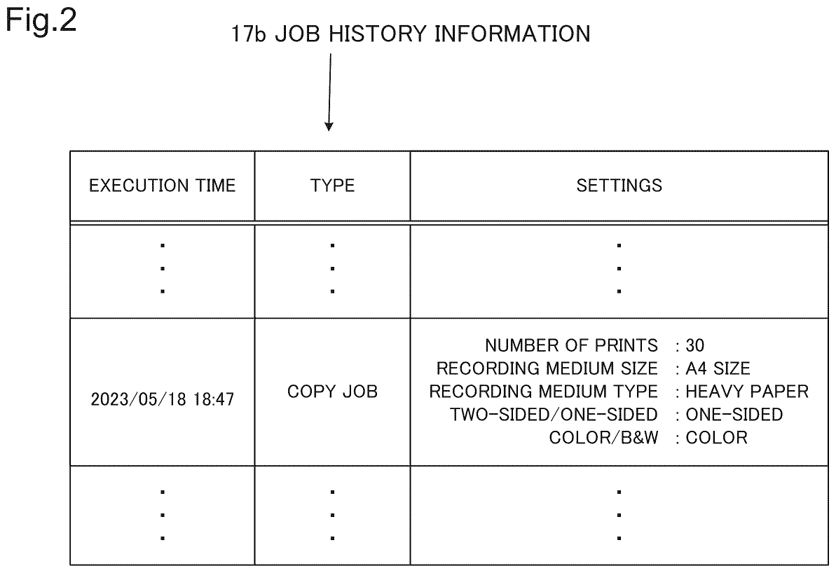

FIG. 2 is a table showing an example of the job history information 17b.

As shown in FIG. 2, the job history information 17b contains, as a history for each job, the execution time of the job, the type of the job, such as copy job or print job, and settings for the job. The history thus contained into the job history information 17b covers all information necessary for estimating CO2 emissions based on a CO2 emission estimation model to be described hereinafter.

The controller 18 shown in FIG. 1 includes, for example, a CPU (central processing unit), a ROM (read only memory) that stores programs and various types of data, and a RAM (random access memory) as a memory for use as a working area for the CPU of the controller 18. The CPU of the controller 18 executes a program stored in the storage device 17 or the ROM of the controller 18.

By executing the CO2 emission estimation program 17a, the CPU of the controller 18 functions as a CO2 emission estimator 18a that estimates the CO2 emissions from the image forming apparatus 10.

The following formula is a CO2 emission estimation model as a formula used by the CO2 emission estimator 18a in estimating the CO2 emissions from the image forming apparatus 10 when performing one job.

$$\hat{y} = ( {a}_{1} {x}_{1} + {a}_{2} {x}_{2} + ⋯ + {a}_{n} {x}_{n} + b ) \times ( CO 2 emission factor ) \qquad [ Math . 1 ]$$

ŷ: objective function (estimated value of CO2 emissions)
xₙ: explanatory variable
aₙ: partial regression coefficient
b: constant term

Different CO2 emission estimation models are prepared, one for each type of job.

In the CO2 emission estimation model, an arithmetic expression inside parentheses on the right side of the formula is a multiple regression expression (hereinafter, referred to as a “power consumption estimation model”) for determining an estimated value of a power consumption of the image forming apparatus 10 when performing one job.

In the CO2 emission estimation model, n is an integer of 2 or more.

In the CO2 emission estimation model, explanatory variables xₙ may be present, for example, each according to a different type of setting for a targeted job.

For example, there may be employed as xₙ a variable depending on the number of prints indicating the number of recording media on which images are to be printed in a targeted job. For example, in the case of copying under the condition that a single sheet of original document is placed on an original glass plate, a set number of copies to be printed may be treated as the number of prints in the copy job. For another example, in the case of copying under the condition that a plurality of sheets of original document are placed in a DP (automatic document feeder) and when an image forming apparatus has a preview and print function of previously reading all the sheets of original document, making various settings on a print preview display screen, and then performing copying, the product of the number of sheets of original document read and a set number of copies to be printed may be treated as the number of prints in the copy job.

Furthermore, there may be employed as xₙ, for example, a variable depending on recording medium size indicating the size of recording media on which images are to be printed in a targeted job. The value of an explanatory variable xₙ depending on recording medium size may be determined according to the recording medium size, such as, for example, 5 for A4 size or 2 for A5 size. The value of an explanatory variable depending on recording medium size may be, for example, a value proportional to the area of the recording medium size.

Furthermore, there may be employed as xₙ, for example, a variable depending on recording medium type indicating the type of recording media on which images are to be printed in a targeted job. The value of an explanatory variable xₙ depending on recording medium type may be determined according to the recording medium type, such as, for example, 3 for heavy paper, 2 for plain paper, or 1 for thin paper. The value of an explanatory variable depending on recording medium type may be, for example, a value proportional to the thickness of the recording medium type. The explanatory variable depending on recording medium type may be set for each recording medium type. In setting an explanatory variable depending on recording medium type for each recording medium type, the value of an explanatory variable for each recording medium type may be, for example, 1 when a targeted recording medium type is specified in settings for the job and 0 when the targeted recording medium type is not specified in settings for the job. As an example, in setting an explanatory variable depending on recording medium type for each recording medium type, the value of an explanatory variable for heavy paper may be 1 when heavy paper is specified as the recording medium type in settings for the job and 0 when heavy paper is not specified as the recording medium type in settings for the job.

Moreover, there may be employed as xₙ, for example, a variable depending on two-sided/one-sided indicating whether two-sided printing or one-sided printing is to be performed in a targeted job. The value of an explanatory variable xₙ depending on two-sided/one-sided may be, for example, 1 when two-sided printing is selected in settings for the job and 0 when one-sided printing is selected in settings for the job.

Furthermore, there may be employed as xₙ, for example, a variable depending on color/B&W indicating whether multicolor printing or black-and-white printing is to be performed in a targeted job. The value of an explanatory variable xₙ depending on color/B&W may be, for example, 1 when multicolor printing is selected in settings for the job and 0 when black-and white printing is selected in settings for the job. The explanatory variable depending on color/B&W may be set separately for each of multicolor printing and black-and-white printing. In setting an explanatory variable depending on color/B&W separately for each of multicolor printing and black-and-white printing, the value of an explanatory variable for multicolor printing may be, for example, 1 when multicolor printing is selected in settings for the job and 0 when multicolor printing is not selected in settings for the job. Likewise, in setting an explanatory variable depending on color/B&W separately for each of multicolor printing and black-and-white printing, the value of an explanatory variable for black-and-white printing may be, for example, 1 when black-and-white printing is selected in settings for the job and 0 when black-and-white printing is not selected in settings for the job.

Furthermore, there may be employed as xₙ, for example, a variable depending on aggregation indicating the number of pages to be printed on one side of a recording medium. The value of an explanatory variable depending on aggregation may be, for example, 8 when “no aggregation” indicating that the number of pages to be printed on one side of a recording medium is 1 is selected in settings for the job, 4 when “2 in 1” indicating that the number of pages to be printed on one side of a recording medium is 2 is selected in settings for the job, 2 when “4 in 1” indicating that the number of pages to be printed on one side of a recording medium is 4 is selected in settings for the job, and 1 when “8 in 1” indicating that the number of pages to be printed on one side of a recording medium is 8 is selected in settings for the job.

When the power consumption of the image forming apparatus 10 performing a job varies depending on the location of a medium feeding device through which a recording medium to be printed in a targeted job is fed, such as when the number of motors driven to convey the recording medium varies depending on the location of the medium feeding device through which the recording medium is fed, an employed xₙ may be a variable depending on the location of the medium feeding device through which the recording medium to be printed in the targeted job is fed.

When the power consumption of the image forming apparatus 10 performing a job varies depending on the location of a medium ejection device through which a recording medium to be printed in a targeted job is ejected, such as when the number of motors driven to convey the recording medium varies depending on the location of the medium ejection device through which the recording medium is ejected, an employed xₙ may be a variable depending on the location of the medium ejection device through which the recording medium to be printed in the targeted job is ejected.

When the image forming apparatus 10 has the function of performing post-processing, such as, for example, sorting, stapling, punching or folding, for a recording medium with an image printed thereon, an employed xₙ may be a variable depending on the type of post-processing to be performed for a recording medium on which an image is to be printed in a targeted job.

Moreover, an explanatory variable xₙ may be present, for example, depending on the state of the image forming apparatus 10 when performing a targeted job. For example, there may be employed as xₙ a variable depending on the operation mode of the image forming apparatus 10 as an example of the state of the image forming apparatus 10 when performing a targeted job. Examples of the operation mode of the image forming apparatus 10 include a normal mode and a quiet mode where the operating noise is quieter than in the normal mode. In the quiet mode, a motor for rotating a polygon mirror in the printer 13 is stopped for quiet operation each time the execution of a job is finished, and therefore need to be driven again each time the execution of a job is started. For this reason, the quiet mode consumes more power than the normal mode.

In the CO2 emission estimation model, a constant term b indicates a sum of powers basically required for a targeted job. Powers to be employed as the powers basically required for a targeted job are, for example, a power for raising the temperature of a fixing roller of the printer 13 to a specific temperature before printing and maintaining the temperature, a power for stabilizing, before printing, the rotation of a motor for rotating the fixing roller of the printer 13, and a power for stabilizing, before printing, the rotation of a motor for rotating a polygon mirror of the printer 13.

Next, a description will be given of the configuration of a CO2 emission estimation model generation system for use in generating a CO2 emission estimation model.

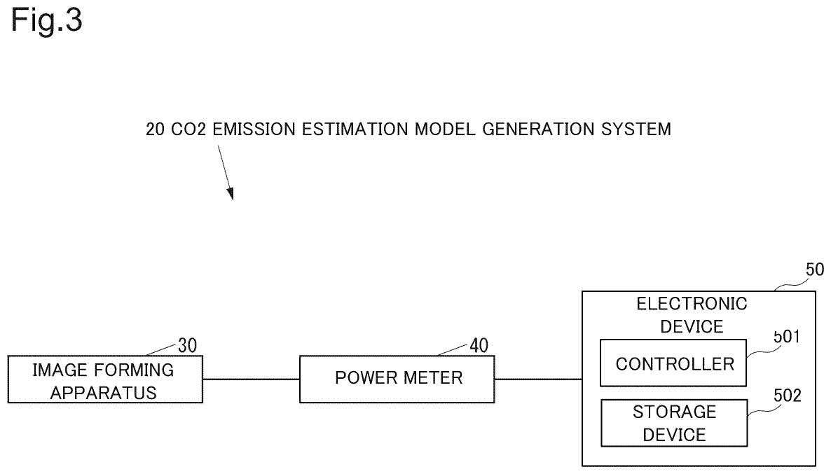

FIG. 3 is a block diagram showing an example of a CO2 emission estimation model generation system 20 for generating a CO2 emission estimation model for use on the image forming apparatus 10.

As shown in FIG. 3, the CO2 emission estimation model generation system 20 includes: an image forming apparatus 30 of the same type as the image forming apparatus 10 (see FIG. 1); a power meter 40 that measures the power consumption of the image forming apparatus 30; and an electronic device 50, such as a smartphone or a tablet, that stores the power consumption measured by the power meter 40.

Next, a description will be given of a method for generating a CO₂ emission estimation model.

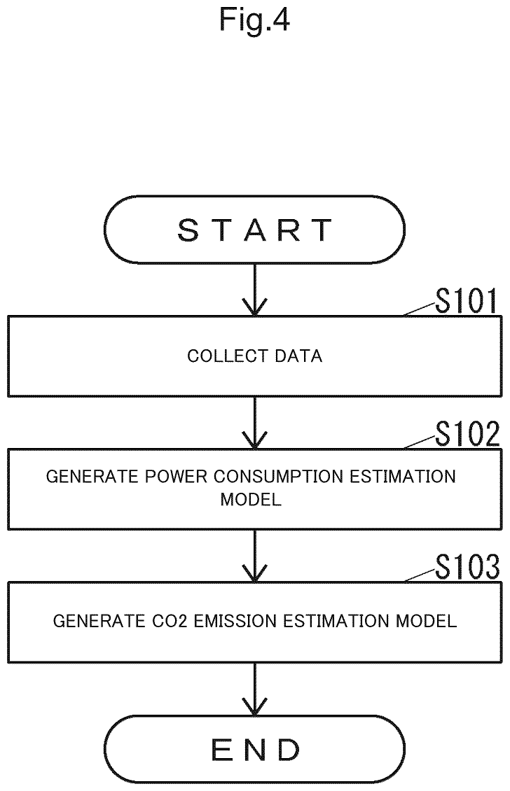

FIG. 4 is a flowchart of a method for generating a CO2 emission estimation model for use on the image forming apparatus 10.

An operator collects a lot of data for use in generating a power consumption estimation model and inputs it to the electronic device 50. A controller 501 of the electronic device 50 allows the collected data input thereto to be stored in a storage device 502 built in the electronic device 50 (S101). Specifically, for each different configuration of settings for a job, the operator inputs, to the electronic device 50, data in which a power consumption measured by the power meter 40 when the image forming apparatus 30 performs the job is associated with the settings for the job performed by the image forming apparatus 30.

After the end of S101, the controller 501 of the electronic device 50 generates a power consumption estimation model by multiple regression analysis using the data stored in S101 (S102). Specifically, the operator inputs to the electronic device 50 an instruction to generate a power consumption estimation model by multiple regression analysis using the data collected in S101. In accordance with this instruction, the controller 501 of the electronic device 50 generates a power consumption estimation model by multiple regression analysis using the data collected in S101. The generation of a power consumption estimation model in S102 may be performed by machine learning.

After the end of S102, the controller 501 of the electronic device 50 uses the power consumption estimation model generated in S102 to generate a CO2 emission estimation model (S103). Specifically, the operator inputs to the electronic device 50 an instruction to generate a CO2 emission estimation model using the power consumption estimation model generated in S102. In accordance with this instruction, the controller 501 of the electronic device 50 multiplies the power consumption estimation model generated in S102 by a CO2 emission factor, thus generating a CO2 emission estimation model.

In the CO2 emission estimation model generation system 20 shown in FIG. 3, only a CO2 emission estimation model for image forming apparatuses of the same type as the image forming apparatus 30 is generated by the controller 501 of the electronic device 50. In generating a CO2 emission estimation model for another type of image forming apparatus, the controller 501 of the electronic device 50 uses type information on the other type of image forming apparatus input to the electronic device 50 to generate a CO2 emission estimation model. The generated CO2 emission estimation model is stored in the storage device 502 or the like.

The CO2 emission estimation model generated by the method shown in FIG. 4 can be extracted or output from the electronic device 50 and installed on an image forming apparatus, such as the image forming apparatus 10, of the same type as the image forming apparatus 30. In other words, the CO2 emission estimation model for use on the image forming apparatus 10 is generated using data in which a power consumption measured by the power meter 40 when the image forming apparatus 30 of the same type as the image forming apparatus 10 performs a job is associated with settings for the job performed by the image forming apparatus 30.

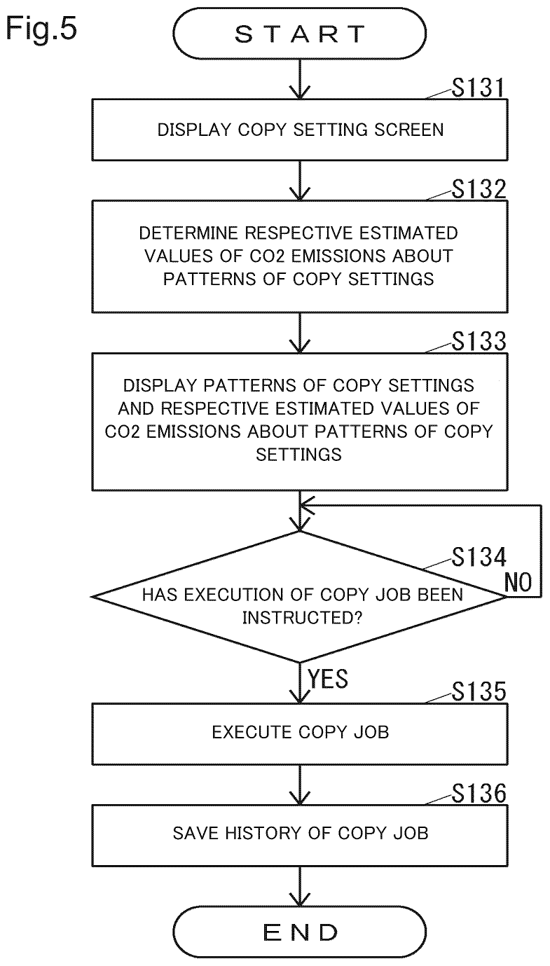

Next, a description will be given of the operation of the image forming apparatus 10 when performing a job. The description below will be given taking copy job as an example of the type of job. However, also when different types of jobs other than copy job are performed, the operation procedure is the same. FIG. 5 is a flowchart of the operation of the image forming apparatus 10 when performing a copy job.

When an instruction to display a setting screen for a copy job (hereinafter, referred to as a “copy setting screen”) is input to the operation device 11, the controller 18 of the image forming apparatus 10 follows this instruction, as shown in FIG. 5, to allow the display device 12 to display the copy setting screen (S131).

When the processing in S131 is finished, the CO2 emission estimator 18a of the image forming apparatus 10 calculates, about a plurality of patterns of setting contents configurable as settings for copy job (hereinafter, referred to as “copy settings”), respective estimated values of CO2 emissions from the image forming apparatus 10 using a CO2 emission estimation model for copy job and each pattern of copy settings (S132).

When the processing in S132 is finished, the CO2 emission estimator 18a allows the plurality of patterns of setting contents as copy settings and the respective estimated values of CO2 emissions from the image forming apparatus 10 determined in S132 about the plurality of patterns of setting contents as copy settings to be displayed on the copy setting screen displayed in S131 (S133). For example, in specifying copy settings by selecting an arbitrary one of the plurality of patterns of copy settings, the user of the image forming apparatus 10 can specify the copy settings with recognition of an estimated value of CO2 emissions from the image forming apparatus 10 about the copy settings.

When the processing in S133 is finished, the controller 18 of the image forming apparatus 10 determines whether an instruction to execute a copy job has been input to the operation device 11 (S134).

When determining in S134 that an instruction to execute a copy job has been input to the operation device 11, the controller 18 executes the copy job according to the copy settings specified on the copy setting screen (S135).

When the processing in S135 is finished, the controller 18 saves the history of the copy job executed in S135 into the job history information 17b (S136) and ends the operation shown in FIG. 5.

In the operation shown in FIG. 5, the CO2 emission estimator 18a allows respective estimated values of CO2 emissions from the image forming apparatus 10 about the plurality of patterns of setting contents as copy settings to be displayed. However, after copy settings are specified on the copy setting screen, the CO2 emission estimator 18b may calculate an estimated value of CO2 emissions from the image forming apparatus 10 using the copy settings specified on the copy setting screen and the CO2 emission estimation model for copy job and allow the calculated estimated value to be displayed on the copy setting screen.

Next, a description will be given of the operation of the image forming apparatus 10 when displaying the total amount of CO2 emissions.

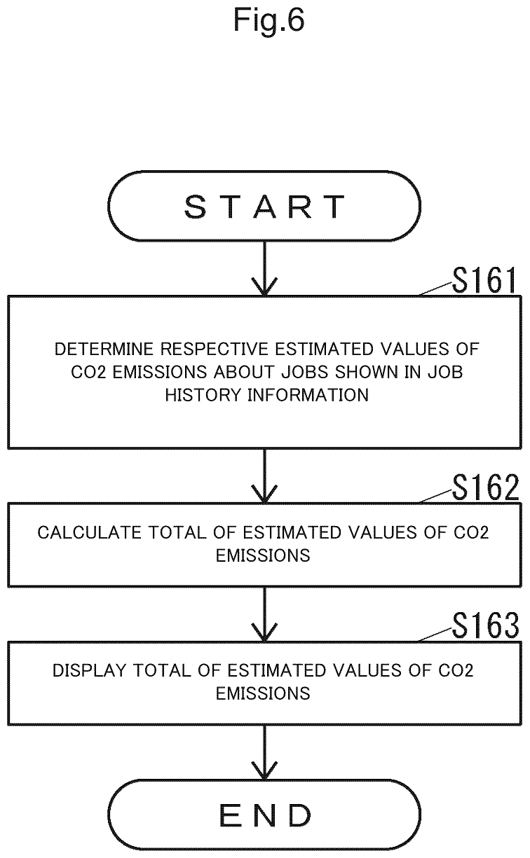

FIG. 6 is a flowchart of the operation of the image forming apparatus 10 when displaying the total amount of CO2 emissions.

When the user operates the image forming apparatus 10 to input to the operation device 11 an instruction to display the total amount of CO2 emissions from the image forming apparatus 10, the CO2 emission estimator 18a calculates, about all jobs shown in the job history information 17b, respective estimated values of CO2 emissions from the image forming apparatus 10 using the settings for each job shown in the job history information 17b and the CO2 emission estimation model according to the type of each job shown in the job history information 17b (S161).

When the processing in S161 is finished, the CO2 emission estimator 18a adds up all the estimated values determined in S161, thus calculating the total of estimated values of CO2 emissions from the image forming apparatus 10 (S162).

When the processing in S162 is finished, the CO2 emission estimator 18a allows the display device 12 to display the total of estimated values of CO2 emissions from the image forming apparatus 10 calculated in S162 (S163). Therefore, the user of the image forming apparatus 10 can recognize the total of estimated values of CO2 emissions from the image forming apparatus 10.

In the operation shown in FIG. 6, the CO2 emission estimator 18a allows the total of estimated values of CO2 emissions from the image forming apparatus 10 over the entire past period to be displayed. However, the CO2 emission estimator 18a may calculate the total of estimated values of CO2 emissions from the image forming apparatus 10 over a specific period, such as a specified period input to the operation device 11 by user's operation of the image forming apparatus 10, and allow the display device 12 to display the calculated total over the specific period.

As thus far described, the image forming apparatus 10 determines an estimated value of CO2 emissions from the image forming apparatus 10 when performing a job, using: a CO2 emission estimation model which is a formula in which a multiply regression expression for determining an estimated value of a power consumption of the image forming apparatus 10 when performing the job is multiplied by a CO2 emission coefficient and which has a plurality of explanatory variables each according to a different type of setting for the job; and the settings for the job (S132 or S161). Therefore, the influence on the estimated value of CO2 emissions from the image forming apparatus 10 is not confused for each explanatory variable and, as a result, the accuracy of the estimated value of CO2 emissions from the image forming apparatus 10 can be increased.

Since the multiple regression expression for determining an estimated value of a power consumption of the image forming apparatus 10 when performing a job contains a constant term indicating a sum of powers basically required for the job, the image forming apparatus 10 can determine an estimated value of CO2 emissions from the image forming apparatus 10 in consideration of the influence of the powers basically required for the job and, as a result, can increase the accuracy of the estimated value of CO2 emissions from the image forming apparatus 10.

Even though the power consumption of the image forming apparatus 10 is not measured by a power meter, the image forming apparatus 10 can determine an estimated value of CO2 emissions from the image forming apparatus 10 using a CO2 emission estimation model.

A recording medium on which an image is to be printed by the image forming apparatus 10 is shipped in a state where, during production of the recording medium itself, its CO2 emissions have been calculated. Likewise, a toner for use in printing on the recording medium by the image forming apparatus 10 is also shipped in a state where, during production of the toner itself, its CO2 emissions have been calculated. Therefore, the estimated value of CO2 emissions from the image forming apparatus 10 when performing a job should not contain the respective estimated values of CO2 emissions about the amount of use of recording media and the amount of use of toner. When the estimated value of CO2 emissions from the image forming apparatus 10 when performing a job does not contain the respective estimated values of CO2 emissions about the amount of use of recording media and the amount of use of toner, the CO2 emission estimator 18a can increase the accuracy of the estimated value of CO2 emissions from the image forming apparatus 10 when performing the job.

In this embodiment, the CO2 emission estimator 18a notifies of the estimated value of CO2 emissions from the image forming apparatus 10 by displaying it. However, the CO2 emission estimator 18a may notify of the estimated value of CO2 emissions from the image forming apparatus 10 by any method other than displaying it. For example, it is possible that the image forming apparatus 10 includes a speaker or the like and the CO2 emission estimator 18a notifies of the estimated value of CO2 emissions from the image forming apparatus 10 by sound from the speaker.

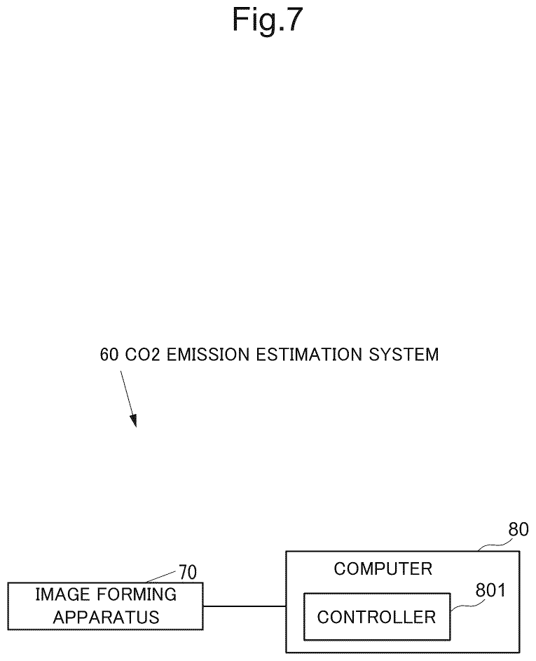

In the above example, the CO2 emission estimation system is formed only of an image forming apparatus. However, the CO2 emission estimation system according to this embodiment may be formed of an image forming apparatus and at least one computer other than the image forming apparatus. For example, the CO2 emission estimation system according to this embodiment may have a configuration shown in FIG. 7.

FIG. 7 is a block diagram showing another example of a CO2 emission estimation system according to this embodiment different from the example shown in FIG. 1.

A CO2 emission estimation system 60 shown in FIG. 7 includes an image forming apparatus 70 and a computer 80. The image forming apparatus 70 and the computer 80 are connected communicably to each other. The computer 80 includes a controller 801 equivalent to the controller 18 included in the image forming apparatus 10, and receives, through an unshown communication device (equivalent to the communication device 15 included in the image forming apparatus 10) included in the computer 80 from the image forming apparatus 70, the type of and settings for a job to be performed or having been performed by the image forming apparatus 70. The controller 801 calculates, based on the received type of the job and the job settings, an estimated value of CO2 emissions from the image forming apparatus 70, like the processing in S132 or S161. The user of the image forming apparatus 70 may be notified of the estimated value of CO2 emissions of the image forming apparatus 70 calculated by the computer 80 from either the image forming apparatus 70 or the computer 80. The computer 80 is an example of the computer defined in CLAIMS.

The CO2 emission estimation systems disclosed in BACKGROUND have a problem of low accuracy of the estimated value of CO2 emissions from an image forming apparatus. Unlike them, in the above embodiment, the accuracy of the estimated value of CO2 emissions from the image forming apparatus can be increased.

While the present disclosure has been described in detail with reference to the embodiments thereof, it would be apparent to those skilled in the art that the various changes and modifications may be made therein within the scope defined by the appended claims.

What is claimed is:

1. A CO2 emission estimation system comprising a controller that includes a processor and functions, through the processor executing a CO2 emission estimation program, as a CO2 emission estimator that calculates an estimated value of CO2 emissions from an image forming apparatus when performing a job, using a CO2 emission estimation model as a formula for estimating the CO2 emissions and settings for the job,
the CO2 emission estimation model being a formula where a multiple regression expression for determining an estimated value of a power consumption of the image forming apparatus when performing the job is multiplied by a CO2 emission factor,
the CO2 emission estimation model having a plurality of explanatory variables each according to a different type of setting for the job.

2. The CO2 emission estimation system according to claim 1, wherein the multiple regression expression includes a constant term indicating a sum of powers basically required for the job.

3. The CO2 emission estimation system according to claim 1,
further comprising a display device,
wherein the CO2 emission estimator allows the display device to display the estimated value of CO2 emissions from the image forming apparatus when performing the job.

4. The CO2 emission estimation system according to claim 1, further comprising:
a display device; and
a storage device that stores job history information,
wherein the CO2 emission estimator calculates, about jobs shown in the job history information, respective estimated values of CO2 emissions from the image forming apparatus using the settings for each of the jobs shown in the job history information and the CO2 emission estimation model according to a type of each of the jobs shown in the job history information and allows the display device to display a total of estimated values which is a sum of the respective estimated values calculated about the jobs.

5. A non-transitory computer-readable recording medium with a CO2 emission estimation program stored thereon,
the CO2 emission estimation program allowing a computer to act as a CO2 emission estimator that calculates an estimated value of CO2 emissions of an image forming apparatus when performing a job, using a CO2 emission estimation model as a formula for estimating the CO2 emissions and settings for the job,
the CO2 emission estimation model being a formula where a multiple regression expression for determining an estimated value of a power consumption of the image forming apparatus when performing the job is multiplied by a CO2 emission factor,
the CO2 emission estimation model having a plurality of explanatory variables each according to a different type of setting for the job.
